(19) United States
(12) Patent Application Publication
(10) Pub. No.: US 2013/0157517 A1
(43) Pub. Date: Jun. 20, 2013

(54) USB SOCKET AND PLUG CAPABLE OF DUAL-SIDE INSERTION

(71) Applicant: Qian Liang, Shenzhen (CN)

(72) Inventor: Qian Liang, Shenzhen (CN)

(21) Appl. No.: 13/813,653

(22) PCT Filed: Apr. 13, 2011
(86) PCT No.: PCT/CN2011/072699

§ 371 Date: Feb. 1, 2013

(30) Foreign Application Priority Data
May 21, 2010 (CN) 201020200939.X

(51) Int. Cl. H01R 24/64

(52) U.S. Cl. CPC H01R 24/64
USPC 439/676

(57) ABSTRACT

A USB (Universal Serial Bus) connector capable of dual-side insertion includes a USB socket and a USB plug. The USB socket includes a socket housing (1), a group of conductive pins provided in the socket housing, and joint plates (4) supporting the group of conductive pins. The group of conductive pins include a first set of conductive pins (2) and a second set of conductive pins (3). The joint plates (4) include an upper joint plate (4.1) and a lower joint plate (4.2). The opposite sides of the upper and lower joint plates are provided with grooves respectively, the number of grooves being equal to the number of conductive pins in the corresponding set of conductive pins. The first and second sets of conductive pins are embedded in the grooves of upper and lower joint plates with the mirrorimage of the first and second sets of conductive pins staggered along the central axis of the socket housing. The socket housing is further provided with a misplug-proof mechanism (1.1,1.2). The USB connector can transmit two USB signals simultaneously, and the space occupied on the device can be decreased.

### FIELD OF THE INVENTION

The invention relates to USB socket and plug, in particular to a USB socket and plug capable of dual-side insertion.

### BACKGROUND OF THE INVENTION

USB is short for Universal Serial Bus. In recent years, personal computers and devices that support USB are increasingly popular, and external devices using USB plug and socket are increasingly plentiful, for example, keyboards, mouse, printers, digital cameras, scanners, game machines and vision facilities etc. An existing USB socket wherein the male connector and the female connector thereof can only be plugged and socketed at a fixed direction, in case of rollover of either of the USB connectors, neither the connectors can be normally plugged and socketed due to limitation of a baffle in the connector or restriction of shape of the connectors, thus failing in constituting signal transmission. The purpose for limitation of the baffle and the connector shape is to ensure that an even number of conductive endpoints on the male connector can be correctly and correspondingly contacted with an even number of conductive endpoints on the female connector. In actual operation and application, it is inconvenient for users to compare and match connectors prior to correcting insertion. In addition, for certain USB devices, adoption of USB sockets only available for unidirectional insertion can lead to failure of normal insertion due to problem resulted from volume. For example, if a memory card with such a USB socket is inserted into a connection port on a computer panel unidirectionally, the USB socket possibly fails to be inserted into the memory card due to obstruction of the memory card body side or other connectors. However, at this time, this problem can be solved easily in case the memory card can be turned over so that the USB connector can be inserted into the other side of the connection port, thus generating signal transmission. Thus it can be seen that a USB socket capable of dual-side insertion indeed can improve convenience of a USB device.

An existing dual-side USB plug (for example, a dual-side USB plug as disclosed on May 6, 2009, with a patent number of ZL 200410084126.8) is matched to a standard USB socket, including two conductive pins contacting with an electrical contactor on a tongue piece of the socket during insertion, and a connector body for bearing the two conductive pins; wherein, the two conductive pins are two sets of conductive pins capable of independently completing standard USB signal transmission, respectively arranged on opposite sides of the connector body. That is to say, the dual-side USB plug device is available for transmission of two sets of USB data. However, concerning USB standard, the dual-side USB plug is short of a USB plug metal construction welded to shielding mesh enclosure wire of a USB data line, which constitutes one of indispensable USB conditions; both the shielding mesh enclosure wire and the USB plug metal construction welded to the shielding mesh enclosure wire are contacted to the metal case of the USB socket, playing a role of signal shielding, which is one of indispensable requirements for a standard USB.

Consequently, the dual-side USB connector plug does not meet indispensable requirements for a standard USB plug due to shortage of the requisite USB plug metal construction welded to shielding mesh enclosure wire of a USB data line; within a certain length of the USB data line, the USB signal is subject to serious attenuation due to lack of shielding effect; in addition, the dual-side USB connector plug is unavailable for application for industrial production and use in life due to comparatively complex structure and high implementation cost.

### DISCLOSURE OF THE INVENTION

The invention provides a USB socket capable of dual-side insertion and a matched USB plug thereof, which is conveniently used for synchronous transmission of two sets of USB data with stable signal.

The invention provides a USB socket capable of dual-side insertion, includes a socket housing, a group of conducting pins provided in the socket housing, and joint plates for supporting the group of conducting pins, wherein the group of conducting pins include a first set of conductive pins and a second set of conductive pins consisting of conductive pins respectively, the joint plates include an upper joint plate and a lower joint plate, opposite sides of the upper joint plate and the lower joint plate are respectively provided with slots equal to, in terms of amount, conductive pins in the group of conducting pins, the first set of conductive pins and the second set of conductive pins are, along the direction of the axle wire of the housing, crisscross inset in the slots of the upper joint plate and the lower joint plate, besides, on the housing is provided with anti-misplug mechanisms.

A USB plug capable of dual-side insertion, includes a plug housing, plug conductive terminals contacting the socket conductive pins groups, and a connector body for supporting the plug conductive terminals, wherein the plug conductive terminals include a first conductive terminal and a second conductive terminal which consist of conductive contact pins respectively, the first conductive terminal and the second conductive terminal are arranged on top and bottom opposite sides of the connector body, and the periphery of the connector body is provided with a metallic shield case.

The USB socket capable of dual-side insertion and the matched USB plug thereof have such advantages as below:

(1) The USB socket capable of dual-side insertion which adopts such a structure can improve convenience for operation of the device. Also, the USB socket capable of dual-side insertion can simultaneously receive signal input from two USB plugs because the first set of conductive pins and the second set of conductive pins of the USB socket capable of dual-side insertion can be connected to two external data modules or conducting wires, thus it can be seen that the USB socket which adopts such a structure can simultaneously transmit two USB signals, thereby saving occupancy space of the device which adopts such a USB socket.

(2) The dual-side USB plug which adopts such a structure wherein when one side of the USB plug is, upward facing to the conductive pins of a computer USB socket, plugged into the computer USB socket, data transmission can be realized as the conductive pins or a golden finger on the upper part of the USB plug contacts a conductive pins in the computer USB socket; besides, data transmission can also be realized as the conductive pins or a golden finger on the lower part of the USB plug contacts a conductive pins in the computer USB socket when the other side of the USB plug is conversely plugged into the computer USB socket; the USB socket capable of dual-side insertion and the matched USB plug thereof are simple in structures, low in cost and suitable for popularization, without distinction between pro and con sequences.

(3) Simultaneous transmission of two USB signals can be realized when dual-side USB plug which adopts such a structure is matched to the USB socket, which is convenient for use in life and time-saving in operation, without distinction between pro and con sequences. Consequently, a plurality of devices which adopt single-group USB signal can be integrated together, thereby saving social resources and overcoming inconvenience in people's daily life, for example, a keyboard and a mouse share such a dual-side USB plug, a flash disk and a card reader share such a dual-side USB plug, a camera and a USB softdog share such a dual-side USB plug etc.

(4) The dual-side USB plug adopting such a structure is matched to the USB socket, which not only increases amount of information for USB interface signal transmission by a portable computer (one dual-side USB interface can transmit two USB signals, therefore two dual-side USB interfaces equivalently amount to four existing single-sided USB interfaces), but also overcomes inconvenience resulted from abandonment of USB interface for the purpose of producing small and exquisite portable computers (for example, IPAD made by Apple Inc); besides, in terms of the space exposed on a portable computer, the dual-side USB plug and socket is less than half compared with an existing single-sided USB plug and socket, which greatly solve the problem that a portable computer is unsightly because the exposure hole of the single-sided USB socket is too large.

### BRIEF DESCRIPTION OF THE DRAWINGS

FIG. 1 is a comparison reference drawing between a three-dimensional schematic diagram and front view of the USB socket capable of dual-side insertion provided by the invention.

FIG. 2 is a breakdown structure diagram for one embodiment of the USB socket capable of dual-side insertion provided by the invention.

FIG. 3 is a structure diagram for showing the location of the joint plates of the USB socket capable of dual-side insertion and for showing the location of the slot of the conductive pins on the upper joint plate and the lower joint plate of the joint plates.

FIG. 4 is a comparison reference drawing between a three-dimensional schematic diagram and front view of another embodiment of the USB socket capable of dual-side insertion provided by the invention.

FIG. 5 is a breakdown structure diagram for another embodiment of the USB socket capable of dual-side insertion provided by the invention.

FIG. 6 shows a comparison reference drawing between a three-dimensional schematic diagram and front view of the USB plug capable of dual-side insertion provided by the invention and shows a comparison diagram of two sides of the plug.

FIG. 7 is a breakdown structure diagram for an embodiment of the USB plug capable of dual-side insertion provided by the invention.

FIG. 8 is a breakdown structure diagram and a three-dimensional schematic diagram for another embodiment of the USB plug capable of dual-side insertion provided by the invention which utilizes a golden finger PCB and a conductive pins group.

FIG. 9 is a breakdown structure diagram and a three-dimensional schematic diagram for another embodiment of the USB plug capable of dual-side insertion provided by the invention.

Further description of the invention is made in detail in conjunction with following drawings and embodiments in order to make objectives, technical schemes and advantages of the invention clearer and more obvious. It shall be understood that the embodiments described here is only used for explanation instead of for restriction of the invention.

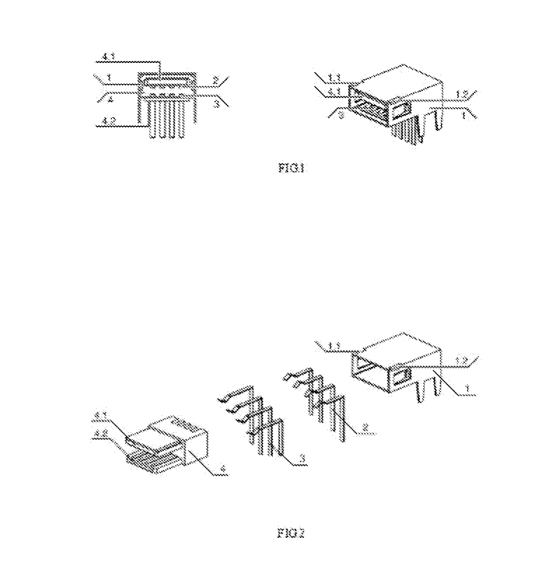

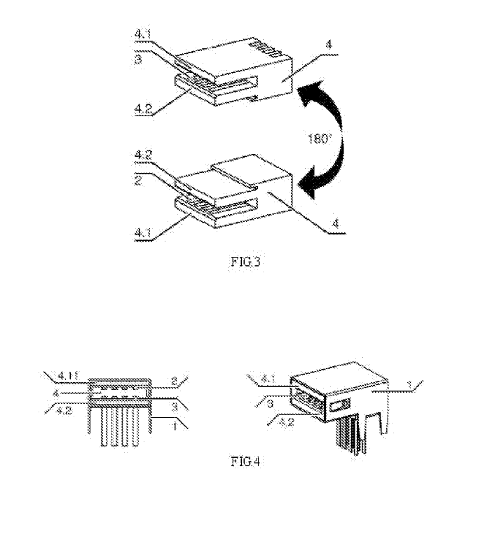

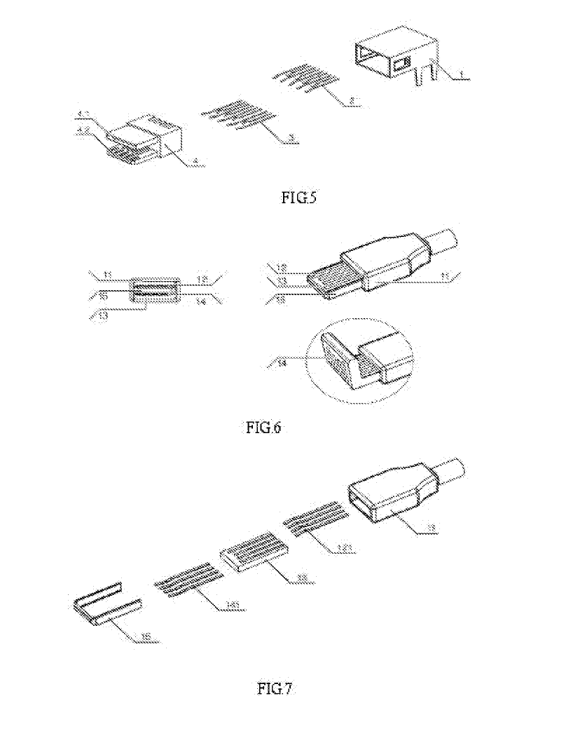

As shown in FIGS. 1-5, the invention provides a USB socket capable of dual-side insertion, particularly:

The invention provides a USB socket capable of dual-side insertion, includes a socket housing 1, a group of conducting pins provided in the socket housing 1, and joint plates 4 for supporting the group of conducting pins, wherein the group of conducting pins include a first set of conductive pins 2 and a second set of conductive pins 3 consisting of conductive pins respectively, the joint plates include an upper joint plate 4.1 and a lower joint plate 4.2, opposite sides of the upper joint plate 4.1 and the lower joint plate 4.2 are respectively provided with slots equal to, in terms of amount, conductive pins in the group of conducting pins, the first set of conductive pins 2 and the second set of conductive pins 3 are, along the direction of the axle wire of the housing, crisscross inset in the slots of the upper joint plate 4.1 and the lower joint plate 4.2, besides, on the socket housing 1 is provided with anti-misplug mechanisms 1.1 and 1.2.

As further improvement of the abovementioned embodiments, the conductive terminals have four or nine conductive contact pins, constituting Mode 2.0 or Mode 3.0 of the USB interface.

The USB socket capable of dual-side insertion which adopts such a structure can improve convenience for operation of the device. Also, the USB socket capable of dual-side insertion can simultaneously receive signal input from two USB plugs because the first set of conductive pins 2 and the second set of conductive pins 3 of the USB socket capable of dual-side insertion can be connected to two external data modules (not shown in the Figs) or conducting wires (not shown in the Figs). Thus it can be seen that the USB socket which adopts such a structure can simultaneously receive signal input from two USB plugs, thereby saving occupancy space of the device which adopts such a USB socket, and simultaneously transmitting an extra USB signal.

Both sides on the upper part of the metal housing of the USB socket capable of dual-side insertion is respectively provided with anti-misplug mechanisms 1.1 and 1.2 used for preventing a product from abnormal use resulted from short circuit of the conductive pins group of the dual-side USB socket due to insertion of an existing single-side USB plug.

As shown in FIG. 6, the invention provides a USB socket capable of dual-side insertion, particularly:

The invention provides a USB plug matched to the USB socket capable of dual-side insertion, includes

a plug housing 11, plug conductive terminals contacting the socket conductive pins groups, and a connector body 13 for supporting the plug conductive terminals, wherein the plug conductive terminals include a first conductive terminal 11 and a second conductive terminal 14 which consist of four conductive contact pins respectively, the first conductive terminal 12 and the second conductive terminal 14 are arranged on top and bottom opposite sides of the connector body 13, and the periphery of the connector body is provided with a metallic shield case 15.

In the embodiment, the conductive terminal has four conductive contact pins respectively serving as the plug of USB2.0. As further improvement of the abovementioned embodiment, refer to FIG. 9, the conductive terminal consists of four long conductive contact pins and five short conductive contact pins, serving as the plug of USB3.0.

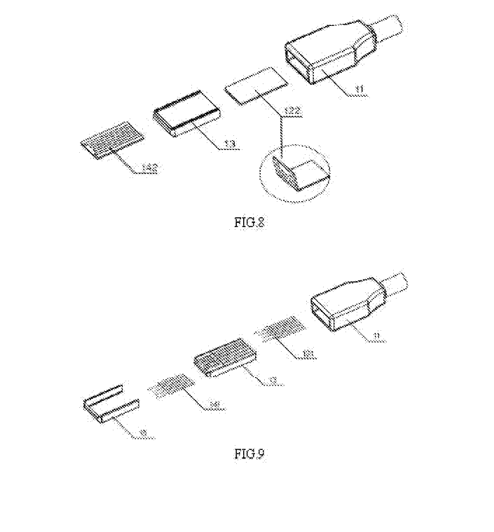

Description of another embodiment is made in order to better understand the invention, please refer to FIG. 7, particularly:

The invention provides a USB plug matched to the USB socket capable of dual-side insertion, includes a plug housing 11, plug conductive terminals contacting the socket conductive pins groups, and a connector body 13 for supporting the plug conductive terminals, wherein the plug conductive terminals include a first conductive terminal 121 and a second conductive terminal 141 which consist of four conductive contact pins respectively, the first conductive terminal 121 and the second conductive terminal 141 are arranged on top and bottom opposite sides of the connector body 13, and the periphery of the connector body is provided with a metallic shield case 15. On top and bottom opposite sides of the connector body are respectively provided with slots equal to, in terms of amount, conductive contact pins; the conductive contact pins of the first conductive terminal 121 and the second conductive terminal 141 are conductive pins which are inset in the slots on top and bottom sides of the connector body 13 and arranged on top and bottom opposite sides of the connector body 13.

Description of another embodiment is made in order to better understand the invention, please refer to FIG. 8, particularly:

The invention provides a USB plug matched to the USB socket capable of dual-side insertion, include a plug housing 11, plug conductive terminals contacting the socket conductive pins groups, and a connector body 13 for supporting the plug conductive terminals, wherein the plug conductive terminals include a first conductive terminal 122 and a second conductive terminal 142 which consist of PCB boards and golden fingers equal to the conductive contact pins in terms of amount, the first conductive terminal 122 and the second conductive terminal 142 are arranged on top and bottom opposite sides of the connector body 13, and the periphery of the connector body is provided with a metallic shield case 15.

The dual-side USB plug adopting such a structure is matched to the USB socket, which increases the amount of information for USB interface signal transmission by a portable computer.

The abovementioned embodiments are preferred embodiments of the invention, not used for limiting the invention. Modifications, equivalent substitutions and improvements made according to principle of the invention shall fall into the protection scope of the invention.

1. A USB socket capable of dual-side insertion, includes a socket housing, a group of conductive pins provided in the socket housing, and joint plates for supporting the group of conductive pins, wherein the group of conductive pins includes a first set of conductive pins group and a second set of conductive pins consisting of conductive pins respectively, the joint plates include an upper joint plate and a lower joint plate, opposite sides of the upper joint plate and the lower joint plate are respectively provided with slots equal to, in terms of amount, conductive pins in the conductive pins groups, the first set of conductive pins and the second set of conductive pins are, along the direction of the axle wire of the housing, crisscross inset in the slots of the upper joint plate and the lower joint plate, besides, on the housing is provided with anti-misplug mechanisms.

2. The USB socket capable of dual-side insertion according to claim 1 wherein the conductive pins group has four or nine conductive pins.

3. A USB plug capable of dual-side insertion, which is matched to the USB socket capable of dual-side insertion according to claim 1, includes a plug housing, plug conductive terminals contacting the socket conductive pins groups, and a connector body for supporting the plug conductive terminals, wherein the plug conductive terminals include a first conductive terminal and a second conductive terminal which consist of conductive contact pins respectively, the first conductive terminal and the second conductive terminal are arranged on top and bottom opposite sides of the connector body, and the periphery of the connector body is provided with a metallic shield case.

4. The USB socket capable of dual-side insertion according to claim 3 wherein the conductive terminals have four or nine conductive contact pins.

5. The USB plug capable of dual-side insertion according to claim 4, wherein on top and bottom opposite sides of the connector body are respectively provided with slots equal to, in terms of amount, conductive contact pins; the conductive contact pins of the first conductive terminal and the second conductive terminal are conductive pins which are inset in the slots on top and bottom sides of the connector body and arranged on top and bottom opposite sides of the connector body.

6. The USB plug capable of dual-side insertion according to claim 4, wherein the first conductive terminal and the second conductive terminal consist of PCB boards and gold fingers.
